(19) United States
(12) Patent Application Publication
(10) Pub. No.: US 2009/0185606 A1
(43) Pub. Date: Jul. 23, 2009

(54) METHOD AND SYSTEM FOR SELECTING AN OPERATION PROFILE

(75) Inventors: Ying Li, Shenzhen (CN); Jun Zhou, Shenzhen (CN)

Correspondence Address: DARBY & DARBY P.C., P.O. BOX 770, Church Street Station, New York, NY, 10008-0770, US

(73) Assignee: Huawei Technologies Co. Ltd., Shenzhen (CN)

(21) Appl. No.: 12/412,572

(22) Filed: Mar. 27, 2009

Related U.S. Application Data
(63) Continuation of application No. PCT/CN2007/070758, filed on Sep. 24, 2007.

(30) Foreign Application Priority Data
Sep. 28, 2006 (CN) 200610152769.0

(51) Int. Cl. H04B 1/38; H04B 3/46

(52) U.S. Cl. 375/222; 375/227; 375/225

(57) ABSTRACT

The invention provides a method and system for selecting an operation profile, which belongs to the field of network communication. In order to solve the problem of the selected operation profile being unsuitable for the broad bandwidth and traffic in the prior art, the invention provides a method for selecting an operation profile, comprising: obtaining channel information of a channel; selecting the operation profile according to the channel information and a predetermined selection rule. The invention also provides a system for selecting an operation profile comprising a channel information obtaining module and a profile selecting module. With the technical solution of the invention, it may select a suitable operation profile self-adaptively according to the actual channel condition.

The present application claims priority from the Chinese patent application 200610152769.0 entitled “Method and System for Selecting an Operation Profile” filed with the Chinese Patent Office on Sep. 28, 2006, the entire content of which is incorporated in the present application by reference herein.

### FIELD OF THE INVENTION

The present invention relates to the field of network communication, and more particularly, to a method and system for selecting an operation profile.

### BACKGROUND

xDSL is a generic term for Digital Subscriber Line (DSL). A series of technology standards have been developed for xDSL, wherein the ITU-T standard family includes ADSL (Asymmetrical Digital Subscriber Line) (G.992.1/2), ADSL2 (second generation ADSL) (G.992.3), ADSL2+ (extend down stream bandwidth ADSL2) (G.992.5), SHDSL (Symmetrical High-speed Digital Subscriber Line) (G.991.2), VDSL (Very high bit rate digital subscriber line) (G.993.1), VDSL2 (second generation VDSL) etc. VDSL2 as the latest technology standard provides a symmetrical access rate up to 100 Mbit/s and flexible measures for power spectrum control, and thus will play the advantage rule for the next generation twisted pairs access technology and may meet the requirement of various services for bandwidth in a long period. Lots of xDSL services, in particularly ADSL services, have been deployed previously, and as we know, VDSL2 have used the frequency band from 4 KHz up to 30 MHz, however within which there are so many other services such as ADSL, AM radio, and amateur radio service etc. Therefore, in order to coordinate these services, each region has made their own VDSL2 band plans, such as band plan 997, 998, China tri-band etc, according to the specific condition of their own region; meanwhile, different total aggregate power and power spectral density (PSD) profiles are designated for these band plans, as shown in FIG. 1.

Table 1 presents the corresponding relationship between PSD profiles and band plans extracted from G.993.2. From Table 1, it can be seen that except for 8a, 8b and 8c, the maximum downstream total aggregate transmission power of all the profiles is 14.5 dBm, while the maximum upstream total aggregate transmission power of all the profiles is 14.5 dBm. Certainly, the PSDs will vary depending on the frequency bandwidths used. Normally, the higher the frequency bandwidth is, the lower the transmitter PSD. In handshake stage of VDSL, parameters such as band plan, profile etc., should be configured, which enables the VDSL modem be trained according to these configured parameters. While under many circumstances, the channel parameters can not be estimated well beforehand. For example, in case of that the line is very long and exceeds 800 m, the frequency band over 8 MHz is not applicable due to too strong attenuation. In this case, if 17a or even 30a is chosen, the performance will be decreased due to the lower PSD instead of being increased. Thus the line rate of VDSL tends to be lower if an improper profile is used.

There are two methods for selecting an operation profile in the prior art. The first method configures a set of line profiles composed of various parameters, where each of the line profiles includes a band plan, a PSD Mask or PSD Limit corresponding to the band plan and other parameters, where the PSD Limit may be a standard value or a customized value lower than the standard value. The system designates one of the above line profiles as the operation profile for the modem of each user. That is to say, once a user selects a profile, the training and static operation thereafter will be based on the selected profile, and the transmission PSD of the modem must meet the requirement of the profile at any time, that is, in a manner of fixed profile.

During design of the present invention, the inventor finds that the above method at least shows the following drawbacks.

Actual lines may vary significantly, therefore, using a profile designated for a line with the fixed profile technology may be not so proper because the bandwidth capacity may be not used fully.

The other method for selecting an operation profile estimates length of a line according to the attenuation of a set of handshake signals transmitted by xTU-R during handshake procedure (in fact the attenuation is estimated according to amplitude of the signal), and then selects an operation profile according to previous running status. For example, ADSL2+ is selected for a loop length less than 2.8 km, ADSL2 for a loop length between 2.8 km and 3.8 km, and ADSL2 annex L for a loop length more than 3.8 km.

Though this technical solution is simple and does not increase the time of the handshake procedure, the inventor finds, during design of the present invention, that the method at least shows the following drawbacks.

The method for determining length of the line according to the upstream handshake signal and selecting a profile according to previous running status is rather unsophisticated that, since the measured attenuation of the upstream signals may not reliably indicate the attenuation in the downstream so as to deduce the capacity, it is often the case that the line rate of the selected profile is relatively low.

TABLE 1

| Band | | Parameter value of profile | | | | | | | |
|---|---|---|---|---|---|---|---|---|---|
| Plan | Parameter | 8a | 8b | 8c | 8d | 12a | 12b | 17a | 30a |
| All | Maximum | +17.5 | +20.5 | +11.5 | +14.5 | +14.5 | +14.5 | +14.5 | +14.5 |
| | downstream | | | | | | | | |
| | transmission | | | | | | | | |
| | power (dBm) | | | | | | | | |
| All | Minimum | For | For | For | For | For | For | For | For |
| | downstream | further | further | further | further | further | further | further | further |
| | transmission | study | study | study | study | study | study | study | study |
| | power (dBm) | | | | | | | | |
| All | Maximum | +14.5 | +14.5 | +14.5 | +14.5 | +14.5 | +14.5 | +14.5 | +14.5 |
| | upstream | | | | | | | | |
| | transmission | | | | | | | | |
| | power (dBm) | | | | | | | | |
| All | Minimum | For | For | For | For | For | For | For | For |
| | upstream | further | further | further | further | further | further | further | further |
| | transmission | study | study | study | study | study | study | study | study |
| | power (dBm) | | | | | | | | |
| All | Bandwidth of | 4.3125 | 4.3125 | 4.3125 | 4.3125 | 4.3125 | 4.3125 | 4.3125 | 8.625 |
| | tone (kHz) | | | | | | | | |
| All | Support to | Required | Required | Required | Required | Required | Not | Not | Not |
| | upstream | | | | | | Required | required | required |
| | band | | | | | | | | |
| | zero(US0) | | | | | | | | |
| All | Minimum | 50 Mbit/s | 50 Mbit/s | 50 Mbit/s | 50 Mbit/s | 68 Mbit/s | 68 Mbit/s | 100 Mbit/s | 200 Mbit/s |
| | bidirectional | | | | | | | | |
| | net data rate | | | | | | | | |
| | capability | | | | | | | | |
| | (Mbit/s) | | | | | | | | |
| Annex | Highest | 8.5 | 8.5 | 8.5 | 8.5 | 8.5 | 8.5 | N/A | N/A |
| A, | downstream | | | | | | | | |
| Annex | frequency | | | | | | | | |
| B (998) | (MHz) | | | | | | | | |
| | Highest | 5.2 | 5.2 | 5.2 | 5.2 | 12 | 12 | N/A | N/A |
| | upstream | | | | | | | | |
| | frequency | | | | | | | | |
| | (MHz) | | | | | | | | |
| Annex | Highest | 7.05 | 7.05 | 7.05 | 7.05 | 7.05 | 7.05 | N/A | N/A |
| B (997) | downstream | | | | | | | | |
| | frequency | | | | | | | | |
| | (MHz) | | | | | | | | |
| | Highest | 8.832 | 8.832 | 5.1 | 8.832 | 12 | 12 | N/A | N/A |
| | upstream | | | | | | | | |
| | frequency | | | | | | | | |
| | (MHz) | | | | | | | | |
| Annex | Highest | 8.5 | 8.5 | 8.5 | 8.5 | 8.5 | 8.5 | 17.664 | 18.1 |
| C | downstream | | | | | | | | |
| | frequency | | | | | | | | |
| | (MHz) | | | | | | | | |
| | Highest | 5.2 | 5.2 | 5.2 | 5.2 | 12 | 12 | 12 | 30 |
| | upstream | | | | | | | | |
| | frequency | | | | | | | | |
| | (MHz) | | | | | | | | |

### SUMMARY

To solve the problem of the selected operation profile being unsuitable for the line bandwidth and traffic, an embodiment of the invention provides a method and system for selecting an operation profile. The technical solution is as follows.

An embodiment of the invention provides a method for selecting an operation profile including:

obtaining channel information of a channel; and

selecting the operation profile according to the channel information and a predetermined selection rule.

Another embodiment of the invention provides a system for selecting an operation profile including:

a channel information obtaining module adapted to obtain channel information of a channel; and

a profile selecting module adapted to select the operation profile according to the obtained channel information and a predetermined selection rule.

With the technical solutions provided by embodiments of the invention, the following advantages may be achieved that, after obtaining the channel information, an operation profile may be selected self-adaptively according to the actual channel condition and the optimal operation profile may be selected by training only once.

### BRIEF DESCRIPTION OF THE DRAWING(S)

FIG. 1a is a schematic view of the band plan for VDSL2 in North America in the prior art;

FIG. 1b is a schematic view of the band plan for VDSL2 in Europe in the prior art;

FIG. 1c is a schematic view of the band plan for VDSL2 in Japan in the prior art;

FIG. 2 is a flow chart of a method for selecting an operation profile according to embodiment one of the invention;

FIG. 3 is a flow chart of a method for selecting an operation profile according to embodiment two of the invention;

FIG. 4 is an illustrative diagram showing the relationship between attenuation and frequency calculated from an estimated electrical length according to an embodiment of the invention;

FIG. 5 is a diagram illustrating the relationship between the PSD Mask, the MIB PSD profile and the amateur radio band according to an embodiment of the invention;

FIG. 6 illustrates a schematic view of a transmission PSD profile based on band plan according to an embodiment of the invention;

FIG. 7 is a diagram illustrating the band plan according to an embodiment of the invention; and

FIG. 8 is a schematic view of a system for selecting an operation profile according to an embodiment of the invention.

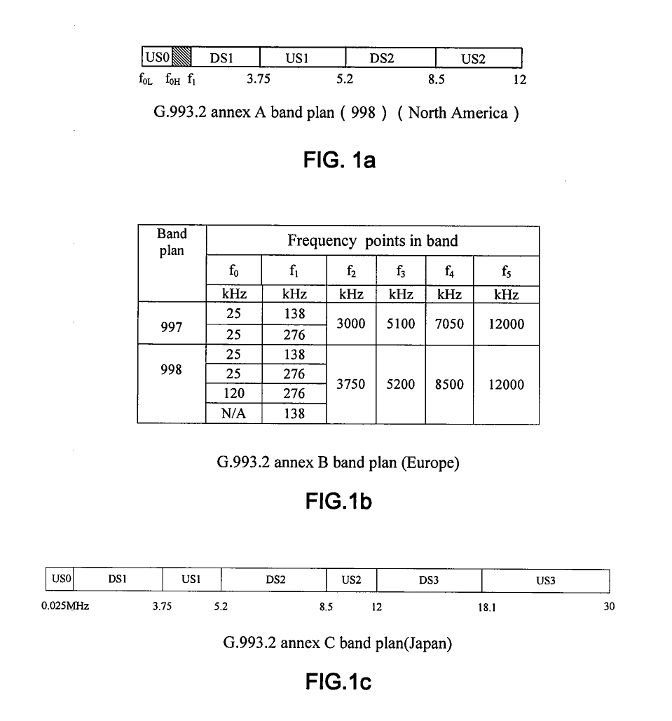

### DETAILED DESCRIPTION

In the following, embodiments of the invention will be further described with reference to the drawings, which do not intend to limit the invention.

Embodiments of the invention provide a method and system for selecting an operation profile. The technical solution self-adaptively selects a profile according to the condition of a channel and preset parameters.

### Embodiment One

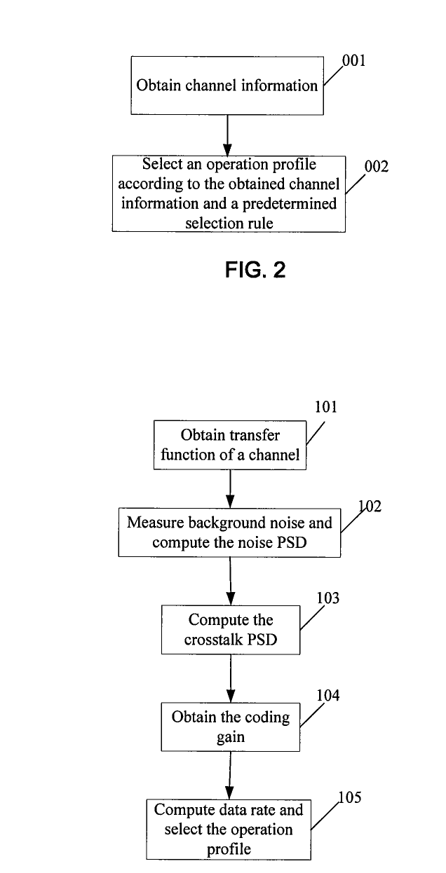

With reference to FIG. 2, a method for selecting an operation profile is shown, which includes the following steps:

Step 001: channel information of a channel is obtained.

This Step Involves the Following Steps:

(1) The electrical length of the channel is estimated according to the received level and transmission level of a set of handshake signals during handshake procedure of an upstream unit and a downstream unit, for example, by using an average algorithm or weighted algorithm.

(2) Attenuation value of the channel, i.e., the transfer function of the channel, over the whole band is calculated according to the electrical length.

(3) Noise PSD is measured according to the handshake signal during the handshake procedure of the upstream unit and downstream unit.

(4) The coding gain is obtained according to the used code.

(5) The transmission signal PSD is calculated according to the band plans and profiles supported by the user side device and the central office device.

(6) The signal to noise ratio (SNR) is calculated according to the transmission signal PSD and the noise PSD.

(7) The bit load that may be carried on each tone is calculated according to the SNR and the coding gain, and the upstream line rate and downstream line rate are calculated to according the bit load that may be carried for whole frequency band.

Step 002: an operation profile is selected according to the obtained channel information and a predetermined selection rule.

The corresponding selection rule may be selecting a profile allowing the maximum upstream line rate or the maximum downstream line rate or the maximum sum of the upstream line rate and downstream line rates.

Alternatively, the corresponding selection rule may be selecting a profile allowing the minimum total aggregate device transmission power or the maximum noise margin or the highest line stability.

### Embodiment Two

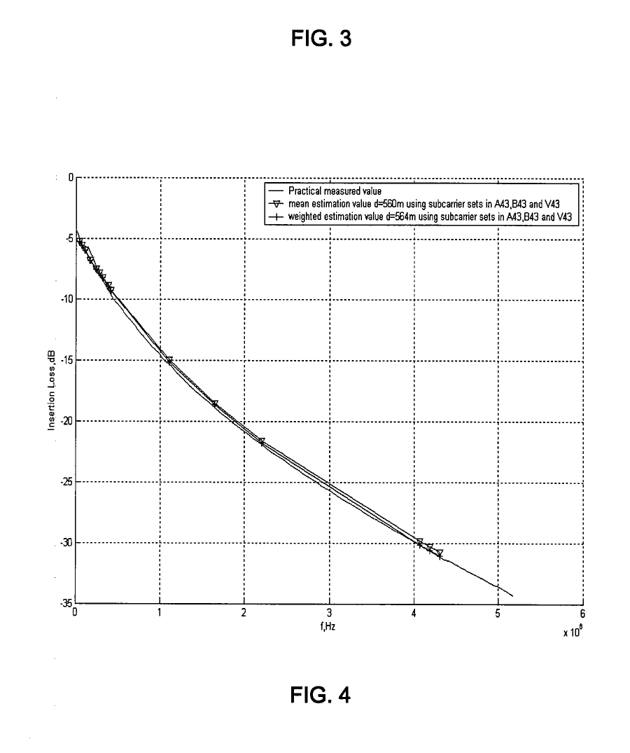

Selecting an operation profile for VDSL2 annex A 998 is taken as an example in the embodiment. There are totally six profiles, 8a, 8b, 8c, 8d, 12a and 12b. In the mentioned six profiles, only 12b dose not support US0 band. Hence in this sense, only the first five of the above six profiles are considered here. With reference to FIG. 3, selecting the operation profile includes the following steps.

Step 101: the transfer function H(ƒ) of a channel is obtained.

The attenuation of a set of G.hs tones may be computed by using the received levels of the tones and the transmission levels of the tones obtained from G.hs (Handshake procedures for VDSL) by a VTU-0 (Remote VDSL Terminal Unit-central office) and VTU-R (VDSL terminal unit-remote). The relationship curve between the attenuation values of a computed set of tones and the frequencies is used to fit a model curve so as to estimate the electrical length of the channel.

There are 12 tone sets used in handshake stage of VDSL2. Taking annex A as an example and with reference to Table 2, tones 9, 17 and 25 of A43 and tones 944, 972 and 999 of V43 are used for the upstream, tones 40, 56 and 64 of A43 and tones 257, 383 and 511 of V43 are used for the downstream. The electrical length (EL) of the channel can be estimated by comparing the actual attenuation values of these signals and the theoretical attenuation values derived from some theoretical DSL channel model, and the electrical length may be in turn used to estimate the transfer function H(ƒ) of the channel.

TABLE 2
G.994.1 - tone sets for 4.3125 kHz signal family

| | Upstream tone set | | Downstream tone set | | |
|---|---|---|---|---|---|
| | Frequency | Maximum power | Frequency | Maximum power | Transmission |
| tone set name | index(N) | level/tone (dBm) | index(N) | level/tone (dBm) | mode |
| A43 | 9 17 25 | −1.65 | 40 56 64 | −3.65 | duplex only |
| (Notes 1, 3, 4) | | | | | |
| A43c | 9 17 25 | −1.65 | 257 293 337 | −3.65 | duplex only |
| (Notes 1, 3, 4) | | | | | |
| B43 | 37 45 53 | −1.65 | 72 88 96 | −3.65 | duplex only |
| B43c(Note 1) | 37 45 53 | −1.65 | 257 293 337 | −3.65 | duplex only |
| C43 | 7 9 | −1.65 | 12 14 64 | −3.65 | duplex only |
| J43 | 9 17 25 | −1.65 | 72 88 96 | −3.65 | duplex only |
| V43(Notes 1, 2) | 944 972 999 | −16.65 | 257 383 511 | −3.65 | duplex only |

With reference to FIG. 4, the transfer function H(ƒ) of the channel is computed from the estimated electrical length.

Here, practical measured value indicates the practically measured value of the attenuation function.

Mean estimation value indicates the value of the attenuation function calculated through estimating the electrical length using an average method. That is, the length is estimated by averaging the several lengths, after the length for each frequency point is estimated.

Weighted estimation value indicates the value of the attenuation function calculated through estimating the electrical length using a weighted average method. The length is estimated using different weights according to the frequencies. That is, after the length for each frequency point is estimated, the weighted average of the lengths is then calculated according to the weight of each frequency point.

It can be seen that the attenuation curve measured using a channel simulator for a diameter of 0.4 m and length of 600 m fits very well with the attenuation curve estimated according to the handshake tones.

Step 102: noise PSD is measured. The measured noise PSD includes a static noise PSD named noise_PSD ( noise PSD can also be measured beforehand) and a crosstalk noise PSD named xtalk_PSD (which indicates sum of a far-end crosstalk and a near-end crosstalk).

Step 104: the coding gain F is obtained according to the used code.

Step 105: the transmission signal PSD is computed under various band plans and profiles supported by the user side device and the central office device. SNR is then calculated according to the transmission signal PSD and noise PSD, then the upstream line rate and downstream line rate are calculated according to the SNR and coding gain. After that, the selecting policy is decided, which is such a policy that it selects a profile enabling the maximum upstream line rate, or the maximum downstream line rate, or the maximum sum of the upstream line rate and downstream line rate.

The Detailed Implementation May Includes:

1) in the case that the band plan and the maximum upstream/downstream transmission power are specified, under the principle of meeting PSD mask requirement and ensuring the aggregate power in the passband being lower than the maximum upstream/downstream transmission power, the transmission signal PSD signal_PSD is measured. Then SNR is calculated using Equation (1) according to the measured noise PSD (including the static noise PSD noise_PSD and the crosstalk noise PSD xtalk_PSD). Then the bit load that may be carried on each tone is calculated using Equation (2), and the upstream/downstream line rates are calculated according to the bit load that can be carried for whole frequency band. Thereafter, the maximum upstream/downstream line rates are obtained according to the calculated upstream/downstream line rates. Here, the policy for selecting the profile is to have the maximum upstream line rate or the maximum downstream line rate or the maximum sum of the upstream line rate and downstream line rate. Currently, many operators limit the maximum upstream/downstream rates. In this case, when the calculated rates may meet the requirement of the supported operation profile, then the operation profile may be selected according to the principles of minimum device transmission power, maximum noise margin, maximum line stability etc.

$$\begin{matrix}S N {R}_{i} = \frac{{signal\_PSD}_{i} \cdot {\vert H ( f ) \vert}^{2}}{{xtalk\_PSD}_{i} + noise\_PSD} & ( 1 ) \\ {b}_{i} = {log}_{2} ( 1 + \frac{S N {R}_{i}}{Γ} ) , i = 1 … k & ( 2 )\end{matrix}$$

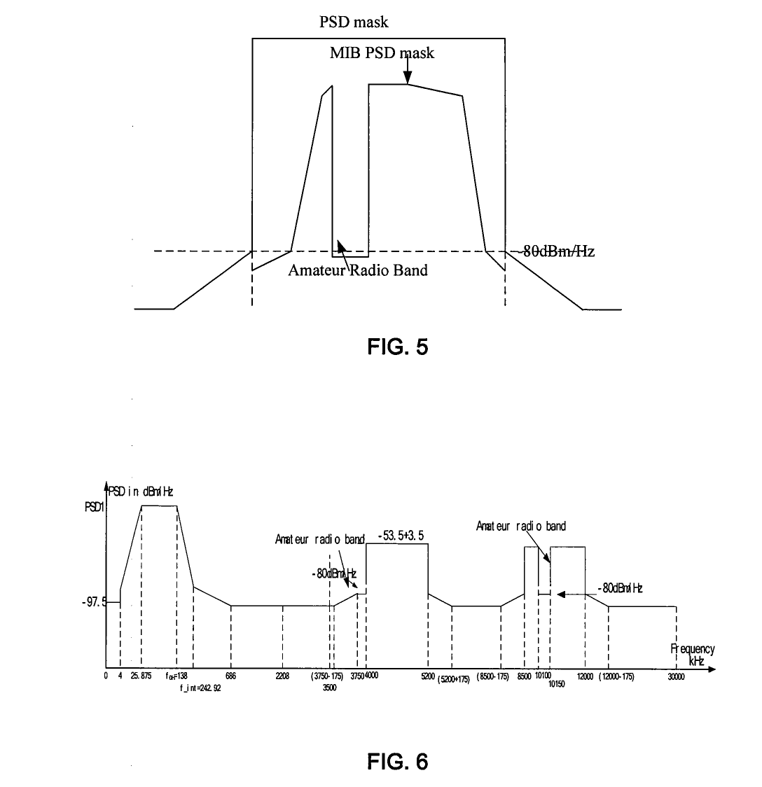

2) in the case that the band plan is not specified and several maximum transmission powers are allowed, the parameters of several band plans and profiles are computed. Considering the limit PSD mask of the band plan, MIB PSD mask and amateur radio band (the relationship between them is shown in FIG. 5), and under the principle of ensuring the aggregate power in the passband being lower than the maximum transmission power, the transmission signal PSD signal_PSD is determined, and then the upstream/downstream rates for the several profiles supported by the VDSL2 are respectively calculated using Equations (1) and (2) according to the measured noise PSD (including the static noise PSD noise_PSD and the crosstalk noise PSD xtalk_PSD). The calculated upstream/downstream rates for the several profiles are compared and a profile is selected allowing for the maximum upstream line rate or the maximum downstream line rate or the maximum sum of the upstream line rate and downstream line rate. Currently, many operators limit the maximum upstream/downstream rate. In this case, when the calculated rates meet the requirement of the supported operation profile, then the operation profile may be selected according to the principles of minimum device transmission power, maximum line noise margin, or maximum line stability etc.

Next, the above method will be explained by taking G 992.3 Annex a as an example.

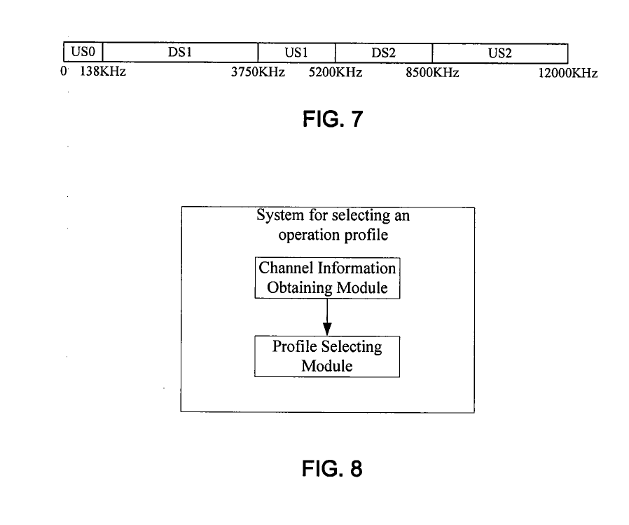

FIG. 6 illustrates the VDSL2 transmission PSD mask based on the band plan shown in FIG. 7. Table 3 shows the downstream PSD used for the profile of 12a in the example, and Table 4 shows the upstream PSD used for the profile of 12a in the example. The PSD values between the frequency points are obtained using an interpolation method. When the maximum aggregate upstream and downstream power is specified as 14.5 dBm, the upstream/downstream line rates for Annex a 8d, 12a are calculated by using the above steps 101-105. At 500 m, the obtained upstream rate for 8d is 44.565 Mbps, the obtained downstream rate is 12.72 Mbps, and the sum of the upstream rate and the downstream rate is 57.22 Mbps; and the obtained upstream rate for 12a is 42.401 Mbps, the obtained downstream rate is 27.294 Mbps, and the sum of the upstream rate and the downstream rate is 69.695 Mbps. Therefore, the profile of 12a is selected according to the above information.

TABLE 3

| Frequency (KHz) | PSD (dBm/Hz) |
|---|---|
| 0 | −97.5 |
| 4 | −97.5 |
| 4 | −92.5 |
| 4 | −92.5 |
| 80 | −72.5 |
| 138 | (−47.7-7.1) |
| 138 | (−40-7.1) |
| 1104 | (−40-7.1) |
| 1622 | (−50-7.1) |
| 3750 | (−53.5-7.1) |
| 3750 | −80 |
| (3750 + 175) | −100 |
| (5200 − 175) | −100 |
| 5200 | −80 |
| 5200 | (−55-7.1) |
| 8500 | (−55-7.1) |
| 8500 | −80 |
| (8500 + 175) | −100 |
| 30000 | −100 |

TABLE 4

| Frequency (KHz) | PSD (dBm/Hz) |
|---|---|
| 0 | −97.5 |
| 4 | −97.5 |
| 4 | −92.5 |
| 25.875 | (−38-1.5) |
| 138 | (−38-1.5) |
| 242.92 | −93.2 |
| 686 | −100 |
| 1104 | −100 |
| (3750 − 175) | −100 |
| 3750 | −80 |
| 3750 | (−53-1.5) |
| 5200 | (−53-1.5) |
| 5200 | −80 |
| (5200 + 175) | −100 |
| (8500 − 175) | −100 |
| 8500 | −80 |
| 8500 | (−54-1.5) |
| 12000 | (−54-1.5) |
| 12000 | −80 |
| (12000 + 175) | −100 |
| 30000 | −100 |

The method may also be applicable to VDSL2-compatible ADSL2+ annex A, ADSL2 annex A, ADSL2 annex L, and it may also used to select the profile for ADSL2+ annex B and ADSL2 annex B.

With reference to FIG. 8, an embodiment of the invention also provides a system for selecting an operation profile, including the following modules.

A channel information obtaining module is adapted to obtain channel information of a channel.

A profile selecting module is adapted to select an operation profile of the channel according to the obtained channel information and a predetermined selection rule.

Here the Channel Information Obtaining Module Further Includes:

An SNR computing unit adapted to compute SNR of the channel;

A coding gain obtaining unit adapted to obtain coding gain according to the used code;

A line rate computing unit adapted to calculate bit load that may be carried on each tone according to the SNR and the coding gain, and to compute an upstream/downstream line rate according to the bit load that may be carried for whole frequency band.

Herein, the SNR Computing Unit May Further Include:

A channel transfer function obtaining unit adapted to estimate electrical length of the channel according to received level and transmission level of a handshake signal during a handshake procedure, and to compute transfer function of the channel according to the electrical length;

A noise PSD measuring unit adapted to obtain noise PSD according to a signal measurement background noise during the handshake procedure;

A signal PSD computing unit adapted to compute transmission signal PSD according to various band plans and profiles supported by a modem and an office-end;

An SNR computing unit adapted to compute an SNR according to the transmission signal PSD and the noise PSD.

The selection rule used by the profile selecting module is to select a profile allowing for the maximum upstream line rate or the maximum downstream line rate or the maximum sum of the upstream line rate and downstream line rate. Alternatively, when the line rates meet the rate limit, the operation profile may be selected according to the principle of minimum device transmission power, or the maximum line noise margin or the maximum line stability.

In summary, the embodiments of the invention may obtain the channel information according to the handshake signal of the upstream unit and downstream unit, and may self-adaptively select the operation profile according to the actual channel condition. As a result, an optimal operation profile may be selected with just one training in the system, thereby ensuring the convenient and fast selecting of the operation profile most suitable for the current channel.

The above embodiment is only one of the detailed implementation of the invention. Any modification and replacement within the scope of the technical solution of the invention made by those skilled in the art is intended to fall within the invention.

What is claimed is:

1. A method for selecting an operation profile comprising:
obtaining channel information of a channel; and
selecting the operation profile according to the channel information and a predetermined selection rule.

2. The method for selecting an operation profile of claim 1, wherein the step of obtaining channel information comprises:
computing a signal to noise ratio (SNR) of the channel and obtaining a coding gain according to a used code; and
obtaining upstream/downstream line rates for profiles according to the SNR and the coding gain.

3. The method for selecting an operation profile of claim 2, wherein the step of computing an SNR of the channel comprises:
computing electrical length of the channel according to reception level and transmission level of a handshake signal, and computing transfer function of the channel according to the electrical length;
computing a transmission signal power spectral density (PSD) according to various band plans and profiles supported by a user side device and an office-end device;
obtaining a noise PSD according to a signal measurement background noise during a handshake procedure; and
computing the SNR according to the transmission signal PSD, the transfer function of the channel and the noise PSD.

4. The method for selecting an operation profile of claim 3, wherein the electrical length is computed by using an average algorithm or a weighted average algorithm.

5. The method for selecting an operation profile of claim 1, wherein the predetermined selection rule comprises: selecting a profile allowing the maximum upstream line rate, or the maximum downstream line rate or the maximum of the sum of the upstream line rate and downstream line rate.

6. The method for selecting an operation profile of claim 1, wherein the predetermined selection rule comprises: selecting a profile allowing the minimum device transmission power, or the maximum line noise margin or the maximum line stability.

7. A system for selecting an operation module comprising:
a channel information obtaining module adapted to obtain channel information of a channel;
a profile selecting module adapted to select the operation profile according to the obtained channel information and a predetermined selection rule.

8. The system for selecting an operation profile of claim 7, wherein the channel information obtaining module comprises:
an SNR computing unit adapted to compute SNR of the channel;
a coding gain obtaining unit adapted to obtain a coding gain according to a used code;
a line rate computing unit adapted to compute bit load that may be carried on each tone according to the SNR and the coding gain, and to compute upstream/downstream line rates according to the bit load that may be carried for whole frequency band.

9. The system for selecting an operation profile of claim 8, wherein the SNR computation unit further comprises:
a channel transfer function obtaining unit adapted to estimate electrical length of the channel according to reception level and transmission level of a handshake signal, and to compute transfer function of the channel according to the electrical length;
a noise PSD measuring unit adapted to compute a noise PSD according to a signal measurement background noise during a handshake procedure;
a signal PSD computing unit adapted to compute a transmission signal PSD according to various band plans and profiles supported by a modem and an office-end; and
an SNR computing unit adapted to compute the SNR according to the transmission signal PSD, the noise PSD and the transfer function of the channel.

10. The system for selecting an operation profile of claim 7, wherein the predetermined selection rule used by the profile selecting module comprises: selecting a profile allowing the maximum upstream line rate, or the maximum downstream line rate or the maximum sum of the upstream line rate and downstream line rate.

11. The system for selecting an operation profile of claim 7, wherein the predetermined selection rule used by the profile selecting module comprises: selecting a profile allowing the minimum device transmission power, or the maximum line noise margin or the maximum line stability.
